(19) United States
(12) Patent Application Publication
(10) Pub. No.: US 2026/0241379 A1
(43) Pub. Date: Aug. 20, 2026

(54) FLUID EJECTION SYSTEM

(71) Applicant: Hewlett-Packard Development Company, L.P., Spring, TX (US)

(72) Inventors: Kenneth Ward, Corvallis, OR (US); Viktor Shkolnikov, Palo Alto, CA (US)

(73) Assignee: Hewlett-Packard Development Company, L.P., Spring, TX (US)

(21) Appl. No.: 19/161,443

(22) PCT Filed: Mar. 24, 2023
(86) PCT No.: PCT/US2023/016200

§ 371 Date: Sep. 2, 2025

(51) Int. Cl. B01L 3/02; B08B 7/00; B08B 9/027; B08B 13/00; G01N 27/02

(52) U.S. Cl. CPC B01L 3/021; B08B 7/0071; B08B 9/027; B08B 13/00; G01N 27/02; B01L 2200/0647; B01L 2200/14; B01L 2300/0645; B01L 2300/1805; B08B 2209/027

(57) ABSTRACT

A fluid ejection device incudes a reservoir to contain a cell solution and a fluid ejection die having an ejector to dispense a cell of the cell solution from the reservoir into a well of a well plate, a channel connecting the reservoir and the ejector, a sense area within the channel, and a clog clearing device proximate the sense area to clear a clog sensed in the sense area.

### BACKGROUND

A cell dispensing system may be used to dispense cells from a cell solution into wells of a well plate or regions of other substrates. The cell solution may be prepared for dispensing by stirring, mixing, and/or otherwise combining one or more components. The cell solution may be strained or treated to reduce clumps of cells. The cell solution may be added to a cell dispense system to eject cells into various regions such as wells of a well plate. Cell dispense systems are sometimes clogged even with carefully prepared cell solutions.

### BRIEF DESCRIPTION OF THE DRAWINGS

Various aspects of the disclosure may now be described with regard to certain examples and embodiments, which are intended to illustrate but not limit the disclosure. Although the examples and embodiments described herein may focus on, for the purpose of illustration, specific systems and processes, one of skill in the art may appreciate the examples are illustrative, and are not intended to be limiting.

FIG. 1 is an example schematic diagram of a fluid ejection device, according to some embodiments.

FIG. 2 is another example schematic diagram of a fluid ejection device, according to some embodiments.

FIG. 3 is an example schematic diagram of a clog clearing system used within the fluid ejection devices of FIG. 1 and/or FIG. 2, according to some embodiments.

FIG. 4 is an example circuit diagram of a sensing circuit used with the clog clearing system of FIG. 3, according to some embodiments.

FIG. 5 is an example graph of an impedance determined by the sensing circuit of FIG. 4 when a single cell is dispensed, according to some embodiments.

FIG. 6 is an example graph of an impedance determined by the sensing circuit of FIG. 4 when a clog is sensed by the sensing circuit, according to some embodiments.

FIG. 7 is an example schematic diagram of a clog clearing system used within the fluid ejection devices of FIG. 1 and/or FIG. 2, according to some embodiments.

FIG. 8 is another example schematic diagram of a clog clearing system used within the fluid ejection devices of FIG. 1 and/or FIG. 2, according to some embodiments.

FIGS. 9A-9B are other example schematic diagrams of a clog clearing system used within the fluid ejection devices of FIG. 1 and/or FIG. 2, according to some embodiments.

FIG. 10 is another example schematic diagram of a clog clearing system used within the fluid ejection devices of FIG. 1 and/or FIG. 2, according to some embodiments.

FIG. 11 is another example schematic diagram of a clog clearing system used within the fluid ejection devices of FIG. 1 and/or FIG. 2, according to some embodiments.

FIG. 12 is another example schematic diagram of a clog clearing system used within the fluid ejection devices of FIG. 1 and/or FIG. 2, according to some embodiments.

FIG. 13 is another example schematic diagram of a clog clearing system used within the fluid ejection devices of FIG. 1 and/or FIG. 2, according to some embodiments.

FIG. 14 is an example electrical transfection system using a clog clearing device, according to some embodiments.

FIG. 15 another example electrical transfection system using a clog clearing device, according to some embodiments.

FIG. 16 is an example flowchart outlining operations for operating the clog clearing system of FIGS. 3 and 7-13, according to some embodiments.

FIG. 17 is an example flowchart outlining operations for operating the clog clearing system of FIGS. 3 and 7-13, according to some embodiments.

FIG. 18 is an example block diagram of a fluid ejection system having the fluid ejection device of FIG. 1 and/or FIG. 2, according to some embodiments.

### DETAILED DESCRIPTION

Various examples now will be described more fully hereinafter with reference to the accompanying drawings. The examples described below may be modified in various forms. To more clearly illustrate the features of the examples, a detailed description thereof will be omitted by those skilled in the art to which the present invention belongs. Examples described hereinafter are for easy understanding of the disclosure, and it should be understood that various changes can be made to the examples described herein and the disclosure can be embodied in different forms. In addition, it should be noted that the drawings as attached are just for easy understanding of the disclosure, and are not illustrated as really scaled, and dimensions of some elements may be exaggerated.

Cell dispensing systems may be used in a wide variety of applications such as laboratory medicine, pharmacology, analytic chemistry, environmental biology, and molecular biology, etc. to, for example, assess or measure the presence, amount, or functional activity of a sample. The sample may include a drug, a genomic sample, a proteomic sample, a biochemical substance, cell of an organism, organic or inorganic substance, chemical substance, or other suitable substances. The cell dispensing system may dispense a small amount of the sample onto a well plate, such as a titration plate. For example, a titration plate may include a plurality of wells that receive the sample from the cell dispensing system. The sample in the plurality of wells may then be measured, analyzed, processed, etc. In some embodiments, single cells of the sample may need to be dispensed into the well plate.

To dispense single cells, a sample cell solution containing the single cells may be prepared. For example, a cell solution may be prepared by mixing one or more components to form the cell solution. The cell solution may contain species that may lead to clogs in the cell dispensing system. To avoid these species from clogging the cell dispensing system, a user may manually pass the cell solution through a strainer to break-up or remove the clumps before adding the cell solution to the cell dispensing system. A clog may refer to a blockage or any hindrance in a regular flow of a cell across an area. The clog may be caused by clumping of the single cell, dust, debris, or other unwanted elements in the cell. In another example, a clog may refer to a gas bubble. The cell solution may be strained to reduce the size and amount of clumps. This additional manual straining step has the potential to introduce contamination, cause cell loss or apoptosis, and lower the efficiency of dispensing single cells. Further, the additional straining step may be time consuming, may have to be repeated periodically, requires additional equipment, and is generally undesirable. Because the cell solution straining process is done manually, it is tedious, complex, inefficient, and may require periodic removal of the cell solution from the cell dispensing system for straining to remove clumps to avoid clogs within the cell dispensing system. Due to inability of the cell dispensing system to disperse clumps or clogs, the cell dispensing system is incapable of dispensing a large number of cells without requiring straining.

Accordingly, the present disclosure provides a fluid ejection system configured to dispense single cells into individual wells of a well plate without requiring frequent straining. Specifically, the fluid ejection system of the present disclosure includes a fluid ejection device having a clog clearing device configured to remove clogs formed by clumps in the cell solution. The clog clearing device may be activated in response to a controller sensing a clog within the fluid ejection system. The clog clearing device may be configured to heat the fluid causing the clog to break away or disperse. The clog may be detected based, for example, on impedance of the sample across two electrodes. The fluid ejection system described herein facilitates dispensing a large number of single cells. Typical single cell dispense systems may only be able to dispense about 400 single cells before a dispense head needs to be changed or re-straining. The fluid ejection system described herein may be able to dispense or singulate up to or over 10,000 cells before the dispense head needs to be changed or re-straining.

The cell dispensing system of the present disclosure may include a sorting dispenser or fluid ejection device and a stage for a multi-well plate. The stage may align itself relative to the dispenser, allowing the dispenser to deliver cells into a new individual wells every time a single cell is to be dispensed. The sorting dispenser includes a hopper reservoir containing a cell solution, a channel including a sense area and an ejector through which the single cells are dispensed onto the well plate. The sense area may include a constriction, flanked by electrodes and the clog clearing device. The clog clearing device may be a thermal inkjet (TIJ) resistor or other type of resistor (generally referred to herein as a resistor). The electrodes are connected to a sensing circuit for sensing a change of impedance across the electrodes.

Depending on the size of the cells and other particulate matter (e.g., dust or debris) in the channel, the impedance across the electrodes in the sense area may vary as the cells travel from the reservoir to the ejector. When the flow in the sense area is unobstructed by a clog, the impedance across the electrodes may be different than the impedance across the electrodes when the flow of cells in (or proximate to) the sense area is obstructed by a clog. For example, large objects, such as undesirable cell clumps may produce a larger clog, and therefore, a larger change in impedance may be observed. When a clog is sensed, the clog clearing device may be activated, first with a low intensity, and then with an increasing intensity, in an attempt to break up and disperse the clog. However, if breaking up a clump cannot be achieved, then the clog clearing device may be fired with higher intensity, lysing the cells and adding momentum to the fluid to help the fluid and clump remnants to pass through the constriction and out of the ejector or pushed back into the reservoir. In some examples, the energy which may be used to break up or lyse the clump of cells may be between 0.1 and 5 micro joules.

Thus, the fluid ejection device of the present disclosure includes a reservoir that supplies cells (e.g., single cells) to the ejector via a channel. The ejector may include one or more nozzles that may be controlled to eject the cell onto a substrate (e.g., well plate) at appropriate times based on a command from a microprocessor or other controller. In particular, each nozzle may include one or more orifices through which the cell is dispensed onto the substrate. The ejector may also include a vaporization chamber that receives the cell to be dispensed. The cell solution may be heated up with one or more heating elements, such as one or more firing resistors. The heating element(s) may be located proximate the vaporization chamber. Heating the fluid using the firing resistor(s) causes the fluid to vaporize and eject the cell solution below the bubble onto the substrate through the nozzle orifices. More specifically, electric current from an external power source may be applied to the firing resistor(s) to heat the firing resistor(s), which then heat a thin layer of the cell solution located within the vaporization chamber causing explosive vaporization and formation of a gas bubble. The expansion of the gas bubble upon vaporization pushes the cell solution out through the nozzle and onto the substrate. As the vaporized gas bubble collapses, the vacuum pressure created acts as suction pump to draw more cell solution from the reservoir into the vaporization chamber. In other embodiments, the one or more dispensing elements may include piezoelectric device such that when voltage is applied to the piezoelectric device, the piezoelectric device changes shape and generates a pressure pulse that pushes the cell solution out of the nozzle orifices. In other embodiments, other types of heating elements or other elements may be used.

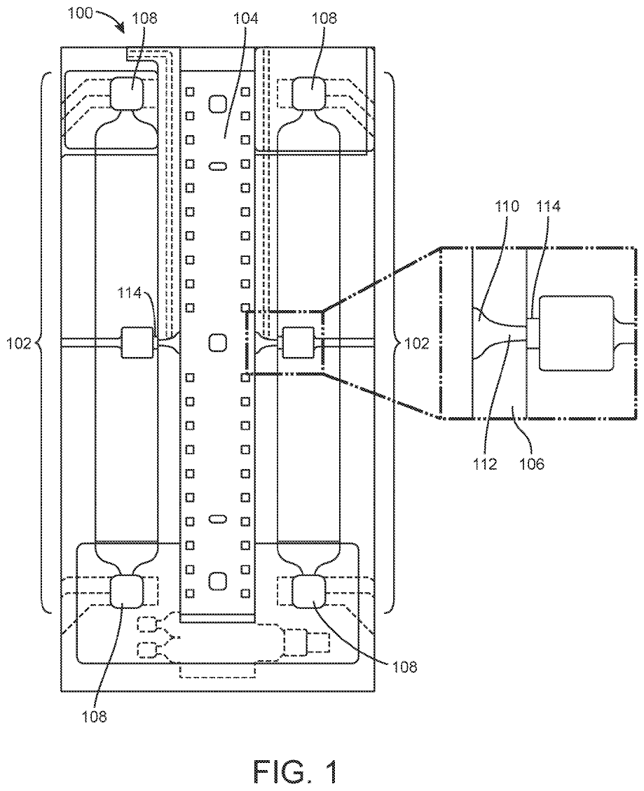

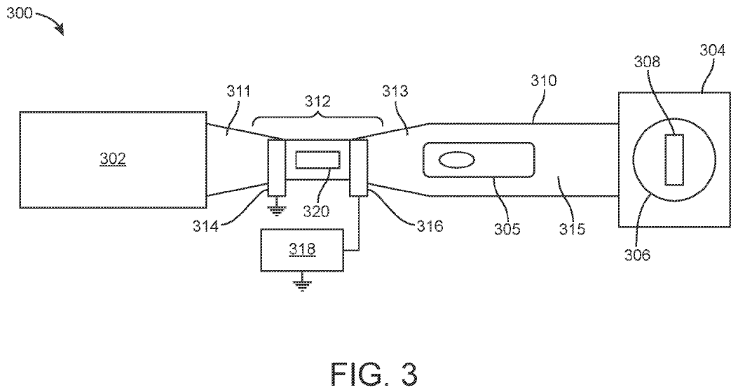

Referring now to FIG. 1, an example schematic diagram of a fluid ejection device 100 is shown, according to some embodiments of the present disclosure. The fluid ejection device 100 includes dispense heads 102 which may receive a cell solution from a reservoir 104. The fluid ejection device 100 includes two dispense heads on either side of the reservoir 104. In the example embodiment shown in FIG. 1, the fluid ejection device 100 includes two dispense heads 102. However, this illustration is meant to be an example and fewer or greater than two dispense heads may be used. A single cell of the cell solution may pass from the reservoir 104 into a channel of the dispense heads 102 and through a sense area 112 within the dispense head, and then eventually ejected into a well plate through an ejector 108. The single cell may enter the dispense heads 102 through a funnel 110 of the channel which directs the single cell into the sense area 112. The sense area 112 may be configured to measure an impedance of the cell solution as the single cell flows through the sense area. The sense area 112 may include electrodes and a sensing circuit to measure the impedance across the electrodes as the cell solution travels from the reservoir 104 to the ejector 108. The sense area 112 is described in more detail below with respect to FIGS. 3 and 7-13.

Based on the measured impedance, a controller may determine whether a clog is present within the sense area 112. Specifically, if the impedance measurement is above a certain threshold or persists for longer than a threshold time, the controller may determine that a clog is present in the sense area 112. If a clog is detected within the sense area 112, a clog clearing device 114 may be activated or fired to remove the clog. In some embodiments, the clog clearing device 114 may be a resistor such as a firing resistor. In some embodiments, the firing resistor may include a resistor connected to a firing switch connected to a ground line. An input of the firing switch may be connected to an output of a firing pulse modulator. The firing pulse modulator may receive a signal (e.g., a voltage signal of a predetermined value, etc.) from the controller in response to detecting a clog. In response to the signal from the controller, the firing pulse modulator may generate a firing signal or firing pulse to the firing switch. The firing signal may cause the firing switch to close and connect the firing resistor to ground, allowing current flow through the resistor and heating the resistor. As the resistor heats up, a portion of the fluid in the channel proximate to the resistor vaporizes to form a gas bubble. This gas bubble pushes fluid through the channel or breaks away the fluid dislodging any clogs which have formed in the channel.

In other embodiments, the resistor implemented as the clog clearing device 114 may be configured to be activated or fired in other ways. In some embodiments, the clog clearing device 114 may be another type of a device such as a thermal element, piezoelectric element, thin film resistor, carbon nanotube films, metal or alloy heating element, ceramic heating element, film based heating element, polymer based heating element, semiconductor heating element, or other types of films, devices, and materials that may be suitable for heating up fluid in the channel for dispersing a clog. In other embodiments, the clog clearing device 114 may be configured to disperse the clog in ways other than, or in addition, to heating (e.g., by changing shape of a piezoelectric device leading to fluid flow, etc.). The clog clearing device 114 may be any device or material that is configured to break, push, disperse, or otherwise remove a clog from the channel in a manner that allows the cell to travel from the reservoir 104 to the ejector 108. In some embodiments, the clog clearing device 114 may be of a suitable size and shape. For example, in some embodiments, the clog clearing device 114 implemented as the firing resistor may be square in shape, having a length of approximately 10-30 microns on each side. In other embodiments, the firing resistor may assume other shapes, including non-geometric shapes. The firing resistor may also have other dimensions and the resistor may assume various resistor values. The clog clearing device 114 may be activated in response to receiving a signal from a controller based on the impedance value determined by the sensing circuit. In other embodiments, the clog clearing device 114 may be a laser which is configured to also heat up the fluid in the channel to vaporize the fluid to form a gas bubble. The clog clearing device 114 is described in more detail below with respect to FIGS. 3 and 7-13.

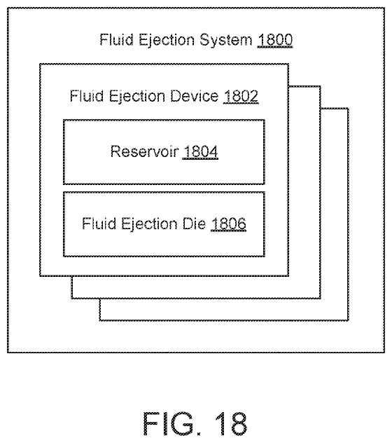

The reservoir, components of the fluid ejection device 100 shown in portion 106 (e.g., the funnel 110, the sense area 112, and the clog clearing device 114), and the ejector 108 may be part of a clog clearing system described in more detail below with respect to FIGS. 3 and 7-13 below. In some embodiments, the channel (e.g., the funnel 110), the sense area 112, and the clog clearing device 114 may be shared by multiple ejectors (e.g., the ejector 108). For example, as shown in FIG. 1, the channel, the sense area 112, and the clog clearing device 114 may be placed centrally within the dispense head 102 which includes the ejectors 108. The ejectors 108 may share the centrally placed elements to clear clogs and clumps formed within the dispense head 102. In other embodiments, a separate instance of the channel (e.g., the funnel 110), the sense area 112, and the clog clearing device 114 may be provided for each instance of the ejector 108. The fluid ejection device 100 may include or be associated with a fluid ejection system with one or more fluid ejection devices. The fluid ejection system is described in more detail below with respect to FIG. 18.

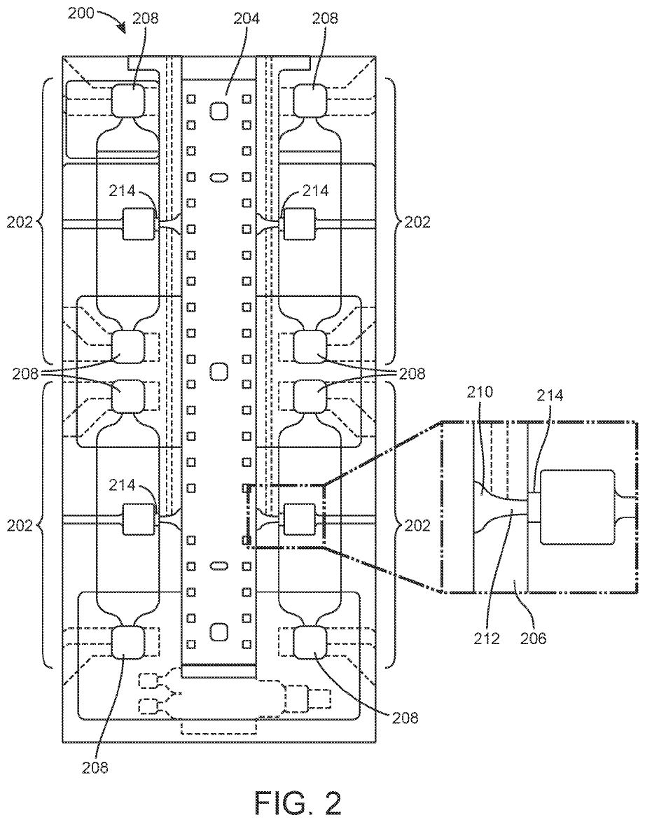

Referring now to FIG. 2, an example schematic diagram of a fluid ejection device 200 is shown, according to some embodiments of the present disclosure. The system 200 may be similar to fluid ejection device 100 but includes four dispense heads 202 whereas the fluid ejection device 100 includes two dispense heads 102. In the example embodiment shown in FIG. 2, the system 200 includes four dispense heads 202. However, this illustration is meant to be an example and fewer or greater than four dispense heads may be used. The system 200 includes dispense heads 202 which may receive a cell solution from the reservoir 204. The cell solution may include single cells which may be passed through the dispense heads 202, sensed by a sense area within the dispense heads 202, and then eventually ejected into a well plate through the ejector 208. The single cell may enter the dispense heads 202 through a funnel 210 which directs the single cell into a sense area 212. The sense area 212 may be configured measure an impedance associated with the sense area 212. Based on the measured impedance, it may be determined whether a single cell or a clog is present within the sense area 212. If it is determined that a clog is present within the sense area 212, a clog clearing device 214 may be activated to remove the clog. The components of the system 200 shown in portion 206 (e.g., the funnel 210, the sense area 212, and the clog clearing device 214) are described in more detail below with respect to FIG. 3 below. More details about the fluid ejection device are provided below with respect to FIG. 18.

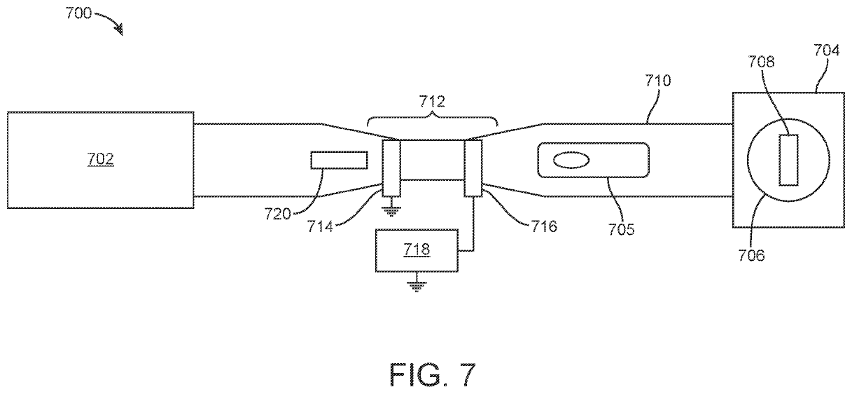

Referring now to FIG. 3, an example schematic diagram of a clog clearing system 300 used within either the fluid ejection device 100 and/or the system 200 is shown, according some embodiments of the present disclosure. As will be illustrated herein (for example, in FIGS. 7-14), multiple embodiments of the clog clearing system 300 may be implemented. None of the clog clearing systems described herein are meant to be limiting. The clog clearing system 300 may include a sense system which measures an impedance across a sense area, determines whether a clog is present based on the measured impedance, and activates a clog clearing device to remove the clog from the sense area.

Specifically, the clog clearing system 300 includes a reservoir 302 which may store the cell solution. A single cell from cell solution may be dispensed from the reservoir to be ejected through an ejector 304. The ejector 304 may include a nozzle 306 and a resistor 308. The resistor 308 may be activated to create a gas bubble which pushes the cell solution containing a single cell 305 through the nozzle in order to dispense the single cell into a well of a well plate positioned under the nozzle of the ejector. In some examples, the ejector 304 dispenses the single cell into a single well within a well plate. The reservoir 302 and the ejector 304 may be connected by a channel 310 in some examples. In some examples, the channel 310 includes a first funnel shaped portion 311 to receive the single cell 305 from the reservoir 302 and direct the single cell 305 into a sense area 312. In some examples, the channel 310 also includes a second funnel shaped portion 313 to receive the single cell 305 from the sense area 312 and push the single cell 305 towards the ejector 304. The sense area 312 may be formed in a constriction connecting the first funnel shaped portion 311 and the second funnel shaped portion 313 of the channel 310. The second funnel shaped portion 313 of the channel 310 may be connected to a channel portion 315 leading to the ejector 304. In some embodiments, the shape and/or the configuration of the channel 310 may vary. For example, in some examples, the sense area 312 may be within a constricted area between the first funnel shaped portion 311 and the second funnel shaped portion 313. However, in other examples, the sense area 312 may be positioned within any location within the channel 310 where clog detection may be desired. The shape, size, and configuration of one or more of the first funnel shaped portion 311, the sense area 312, the first funnel shaped portion 311, and the channel portion 315 may vary in other embodiments.

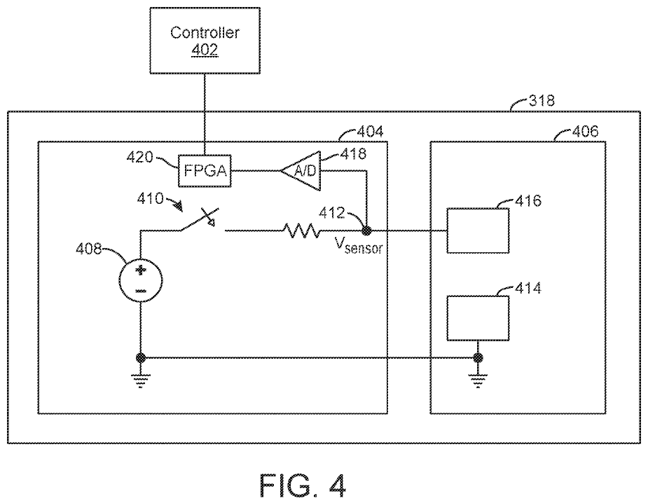

The channel 310 includes the sense area 312 which may be flanked by a first electrode 314 and a second electrode 316. The first electrode 314 and the second electrode 316 may measure the current flow in the sense area 312, in some examples. In some examples, at least one of the first electrode 314 and the second electrode 316 may be coupled to a sensing circuit 318 which may receive the measured current from the first electrode 314 and the second electrode 316 and determine an impedance measurement associated with the sense area 312 based on the measured current. The sensing circuit 318 is described in more detail below with respect to FIG. 4. In the example shown in FIG. 3, the second electrode 316 is coupled to the sensing circuit 318 while the first electrode 314 is connected to ground. However, this illustration is meant to be an example and the sensing circuit 318 could be coupled to any other electrode in the sensing area such as the first electrode 314. Further the examples described herein illustrate the use of two electrodes, however, greater than or fewer than two electrodes may be used within the sense area 312 to determine an impedance. In some examples, the sense area 312 includes the first electrode 314 and the second electrode 316 connected to the sensing circuit 318 to measure an impedance across the sense area 312 as the single cell 305 travels from the reservoir 302 to the ejector 304.

In some examples, the clog clearing system 300 includes a clog clearing device 320. The clog clearing device 320 may be activated or fired to clear a clog within the channel 310 based on an impedance value determined by the sensing circuit 318. In some embodiments, the clog clearing device 320 may be a resistor such as a firing resistor or other thermal device, a piezoelectric element, or other mechanism for moving fluid through the channel 310. The clog clearing device 320 may be activated in response to receiving a signal from a controller based on the impedance value determined by the sensing circuit 318. When the clog clearing device 320 is activated, the clog clearing device 320 heats up. As the clog clearing device 320 heats up, a portion of the fluid in the channel 310 vaporizes to form a gas bubble. This gas bubble pushes fluid through the channel 310 dislodging any clogs or clumps which have formed in the channel 310. In other embodiments, the clog clearing device 320 may be a laser which is configured to also heat up the fluid in the channel 310 to vaporize the fluid to form a gas bubble.

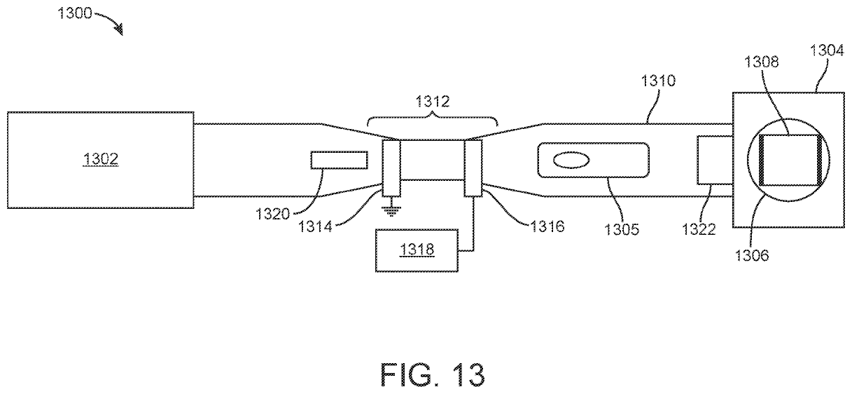

The sensing circuit 318 may be coupled to a controller which is configured to receive the impedance value determined by the sensing circuit 318. The controller may compare the impedance value to a threshold. If the impedance value is at or above the threshold, the controller may be configured to send a signal to activate the clog clearing device 320 to clear the clog from the sense area 312. When the clog clearing device 320 is activated, the clog clearing device 320 may be fired (e.g., a voltage may be applied to the resistor or laser) the fluid (e.g., single cell having the clog) within the channel 310, and particularly in the sense area 312, is heated and forcefully pushed or dispersed to either push the clog back into the reservoir 302 and/or break up the clog so that it may pass through the sense area 312 in smaller pieces. In some examples, the clog clearing device 320 may be activated at multiple intensities and for multiple durations. For example, the clog clearing device 320 may be fired at a first intensity for a first duration during a first attempt at dispersing the clog. If the first attempt is unsuccessful, the clog clearing device may be fired at a second intensity which is higher than the first intensity and/or at a second duration which is higher than the second duration. The intensity and/or duration may continue to vary in other firing iterations of the clog clearing device 320. The clog clearing device 320 may be activated by a power source providing a voltage to the clog clearing device 320. In some examples, the clog clearing device 320 may be a resistor. In another example, the clog clearing device may be a laser such as is shown in FIG. 13 which is explained in more detail below. In the example embodiment shown in FIG. 3, the clog clearing system 300 includes a single clog clearing device 320. However, this illustration is meant to be an example and more than one clog clearing device 320 may be used within the clog clearing system 300. In one example, the clog clearing system 300 may include a combination of both one or more resistor clog clearing devices and one or more laser clog clearing devices.

In one example, the clog clearing device 320 may be activated to clear a clog which appears between the first electrode 314 and the second electrode 316. When the clog occurs between the first electrode 314 and the second electrode 316, the impedance baseline signal associated with the sense area 312 becomes higher than when a clog is not sensed between the first electrode 314 and the second electrode 316. In some embodiments, when the impedance baseline signal is greater than 3 or a pre-determined number of standard deviations (o) from the mean impedance signal, the system 200 activates the clog clearing device 320 to disperse the clog. Specifically, the clog clearing device 320 is fired which heats up the fluid surrounding the clog clearing device 320 thereby dispersing the clog. Then the ejector resistor may be fired to dispense the debris from the clog. After the clog clearing device 320 is fired a pre-determined number of firings, the impedance associated with the sense area 312 is measured again and compared to the mean baseline impedance signal. If the impedance is within 30 of the mean of the baseline impedance signal, then the clog clearing routine is stopped and normal operation is resumed. Otherwise the clog clearing routing is continued. If the clog clearing routine is unable to clear the clog after a predefined number of attempts, an error message is relayed to the user that the cell dispense has stopped and recommending any further actions the user can take to clear the clog.

Referring now to FIG. 4, an example circuit diagram of the sensing circuit 318 is shown in greater detail, according to some embodiments of the present disclosure. The sensing circuit 318 includes a first portion 404 which is configured to charge the sensing circuit 318 and a second portion 406 which is configured to measure the power flow and impedance through the first electrode 314 and the second electrode 316. Specifically, the first portion 404 includes a power source 408 (e.g., a battery) which is configured to charge the sensing circuit 318 on an intermittent basis whenever a switch 410 is closed. The voltage of the sensing circuit 318 is continuously measured by a sensor 412. When the switch 410 is closed and the sensing circuit is being charged, the voltage measured by the sensor 412 may be high. When the switch 410 is open, the sensing circuit 318 begins to discharge and the voltage measured by sensor 412 may begin to drop. The rate at which the sensing circuit 318 discharges may determine the impedance measured in the second portion 406. In some examples, the switch 410 may be configured to open and close at a predetermined rate. For example, the switch 410 may open and close every microsecond. Specifically, the second portion 406 includes a first sensor pad 414 which is in contact with the second electrode 316 and a second sensor pad 416 which is in contact with the first electrode 314. The first sensor pad 414 may be at high potential while the second sensor pad 416 may be at a lower potential (e.g., ground). In that way, the current produced by the cell solution flowing over the first electrode 314 and the second electrode 316 may be measured by the first sensor pad 414 and second sensor pad 416.

As mentioned above, the sensing circuit 318 begins discharging after the switch 410 is opened. However, the rate at which the sensing circuit 318 discharges is based on the current flowing between the first electrode 314 and the second electrode 316. If there are no clogs, the current flowing through the first electrode 314 and the second electrode 316 may be higher and the sensor 412 may measure a higher voltage and a slower discharging rate. If there is a clog, the current flowing through the first electrode 314 and the second electrode 316 may be lower and the sensor 412 may measure a lower voltage with a higher discharging rate. The voltage measured by the sensor 412 (Vₛₑₙₛₒᵣ) may be converted from an analog signal into a digital signal using an analog-to-digital converter 418. The digital signal of the voltage may then be used to determine an impedance associated with the sense area 312 using the field programmable gate array (FPGA) 420. For example, the impedance may be calculated using Equation 1 below:

$$Impedance = \frac{{Voltage}_{sensor}}{Current}$$

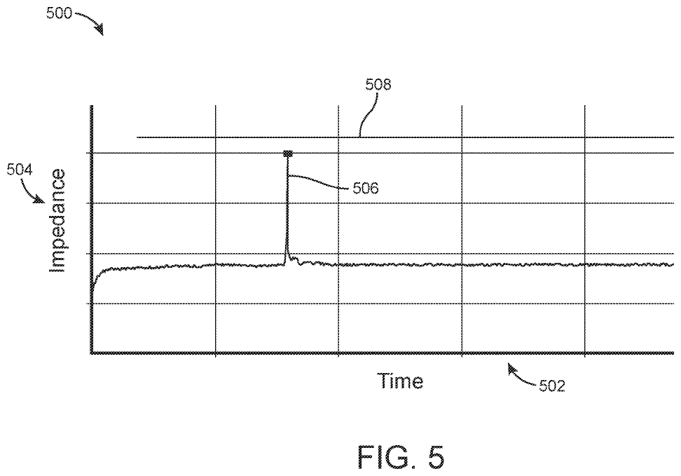

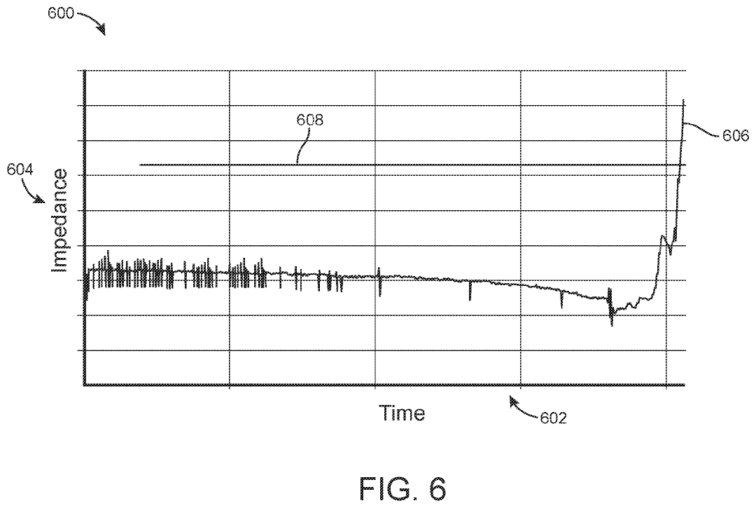

The impedance determined by the FPGA 420 may be communicated to a controller 402 which is configured to compare the impedance to a threshold and activate the clog clearing device 320 in response to the impedance being at or above the threshold. FIGS. 5 and 6 illustrate some example impedances which may be determined by the sensing circuit 318 and are described in more detail below. In some examples, the controller 402 senses the clog in the sense area 312 in response to the impedance being greater than a threshold value.

The controller 402 may be a feedback controller and may include or be associated with one or more processing units or processors and one or more memories. The processing unit(s) may include a microprocessor, programmable logic controller (PLC) chip, an application specific integrated circuit (ASIC), one or more field programmable gate arrays (FPGAs), a digital signal processor (DSP), a group of processing components, or other suitable electronic processing components. The processing unit(s) of the controller 402 may be configured to execute computer-readable instructions for performing the operations described herein. The processing unit(s) may be implemented in hardware, firmware, software, or any combination thereof. “Executing a computer-readable instruction” means that the processing unit(s) may perform operation(s) called for by that instruction. The processing unit(s) may retrieve the instruction from a memory associated with the controller 402 for execution and copy the instruction in an executable form to a physical memory. In some embodiments, the processing unit(s) may be configured to execute the instruction without first copying the instruction to the physical memory. The instruction may be written using one or more programming languages, scripting languages, assembly languages, etc. Thus, the controller 402, via its associated processing unit(s), may be configured to execute instructions, algorithms, commands, or programs stored in the memory associated with the controller 402. In some examples, the controller 402 may be electrically and/or communicably coupled to the clog clearing device 320 and may be configured to provide signal to the clog clearing device 320 which may activate the clog clearing device 320. In some examples, the controller 402 may also be connected to other components within the sensing circuit 318 and control operation of those components. For example, the controller 402 can vary the opening/closing rate of the switch 410.

Referring now to FIG. 5, an example graph 500 of an impedance determined by the sensing circuit 318 is shown, according to some embodiments of the present disclosure. Specifically, the impedance shown in graph 500 may be associated with normal operation (e.g., when no clog is present in the sense area 312) of a fluid ejection device, when a single cell is sensed and dispensed. The graph 500 includes an x-axis 502 which plots time against a y-axis 504 which plots impedance determined by the sensing circuit 318. An impedance spike 506 observed on the graph 500 illustrates an impedance which may be determined by the sensing circuit 318 when a single cell passes through the sense area 312. Specifically, the sensing circuit 318 may compare the impedance within the graph 500 to a threshold 508. Since, the impedance, including the impedance spike 506, is below the threshold 508, the sensing circuit 318 may determine that a clog is not present in the sense area 312 and the impedance spike 506 is instead related a single cell passing through the sense area 312.

Referring now to FIG. 6, another example graph 600 of an impedance determined by the sensing circuit 318 is shown according to some embodiments of the present disclosure. Specifically, the impedance shown in graph 600 may be associated with abnormal operation (e.g., when a clog is present in the sense area 312) of a fluid ejection device when a clog is sensed by the sensing circuit 318. The graph 600 includes an x-axis 602 which plots time against a y-axis 604 which plots impedance determined by the sensing circuit 318. An impedance spike 606 observed on the graph 600 illustrates an impedance which may be determined by the sensing circuit 318 when a clog is sensed in the sense area 312. In one example, the sensing circuit 318 may compare the impedance within the graph 600 to a threshold 608. Since, a peak of the impedance is greater than the threshold 608 at the impedance spike 606, the sensing circuit 318 may determine that a clog is present in sense area 312 and the impedance spike is related a clog forming in the sense area 312. In another example, the sensing circuit 318 may perform shape analysis of the graph 600 to determine whether a clog is present in the sense area 312. For example, the controller may utilize machine learning techniques to recognize various graph shapes which are associated with clogs or clumps being present in the sense area 312. The machine learning techniques may include, but are not limited to convolutional neural nets, U-net CNNs, Long Short-Term Memory Networks (LSTMs), transformer networks. In response to detecting the impedance spike 606, the controller 402 may activate the clog clearing device 320 to clear and disperse the clog. After the clog clearing device 320 has been activated to disperse the clog, the impedance for the sense area may be measured again to determine whether the clog was cleared. If the clog wasn't cleared, the clog clearing device 320 may then be activated again at a higher intensity and/or longer duration. This process may be repeated until the clog is cleared up or up to a pre-determined amount of times. If the clog is not dispersed after the clog clearing device 320 has been fired the pre-determined amount of times, an error message may be displayed on a user interface on or associated with the fluid ejection device 100 and the fluid ejection device 200.

Referring now to FIG. 7, another example schematic diagram of a clog clearing system 700 used within either the fluid ejection device 100 and/or the system 200 is shown, according to some embodiments of the present disclosure. The clog clearing system 700 is similar to the clog clearing system 300 in many respects and includes many of the same components as the clog clearing system 300. For example, the clog clearing system 700 includes a reservoir 702, an ejector 704, a channel 710, and a sense area 712 which are similar to the reservoir 302, the ejector 304, the channel 310, and the sense area 312 respectively of the clog clearing system 300 described above. The ejector 704 includes a nozzle 706 and an ejector resistor 708 which are similar to the nozzle 306 and the resistor 308 respectively. The single cell 705 may be similar to single cell 305. The sense area 712 includes a first electrode 714 and a second electrode 716 which are similar to the first electrode 314 and the second electrode 316 respectively. The first electrode 714 and the second electrode 716 may be connected to a sensing circuit 718 which is configured to measure the impedance across the sense area 712 similar to the sensing circuit 318 described above.

The clog clearing system 700 also includes a clog clearing device 720. The clog clearing device 720 may be activated to clear a clog within the channel 710 based on an impedance value determined by the sensing circuit 718 across the sense area 712. The clog clearing device 720 may be similar to the clog clearing device 320 described above. In one example, the clog clearing system 700 may differ from the clog clearing system 300 in the placement of the clog clearing device 720. The clog clearing device 320 may be placed between the first electrode 314 and the second electrode 316 within the clog clearing system 300. In contrast, the clog clearing device 720 may be placed upstream of the sense area 712 between the reservoir 702 and the first electrode 714. Upstream may refer to the area between the reservoir 702 and the sense area 712. The placement of the clog clearing device 720 within the clog clearing system 700 may be configured to clear clogs which may form upstream of the sense area 712. In some examples, the clog clearing device 720 may be proximate or closer to the sense area 712 than the reservoir 702 to clear a clog sensed in the sense area. In another example, the clog clearing device 720 may be anywhere between the reservoir 702 and the sense area 712. When the clog is sensed upstream from the sense area 712, the clog clearing device 720 may be activated to disperse the clog.

When a clog occurs upstream of the first electrode 714 and the second electrode 716, no cell signal spikes are observed in the impedance signal determined by the sensing circuit 718. When no cell signal spikes are observed after a certain number of firings of the dispense heads or after a predetermined period of time, then the clog clearing device 720 is activated to disperse the clog. For example, during normal operation (e.g., when a clog is not sensed upstream from the sense area) a mean time between when impedance spikes associated with a single cell passing the sense area (such as impedance spike 506) is observed, as well as the corresponding standard deviation o. When no impedance spikes occur after, for example, 3σ after the last impedance spike is observed, a clog is presumed and the clog clearing device 720 is activated. That is, the clog clearing device 720 is fired, followed by the ejector resistor 708 firing to dispense the debris from the clog. After the clog clearing device 720 is fired a pre-determined number of times, the sensing circuit 718 measures the impedance to determine whether the clog has been cleared. To do so, the system waits for, for example, 3σ for the cell peaks to appear. If cell peaks do not occur within the impedance signal, the clog clearing routine is resumed. Otherwise the clog clearing routing is continued. If the clog clearing routine is unable to clear the clog after a predefined number of attempts, an error message is relayed to the user that the cell dispense has stopped and recommending any further actions the user can take to clear the clog.

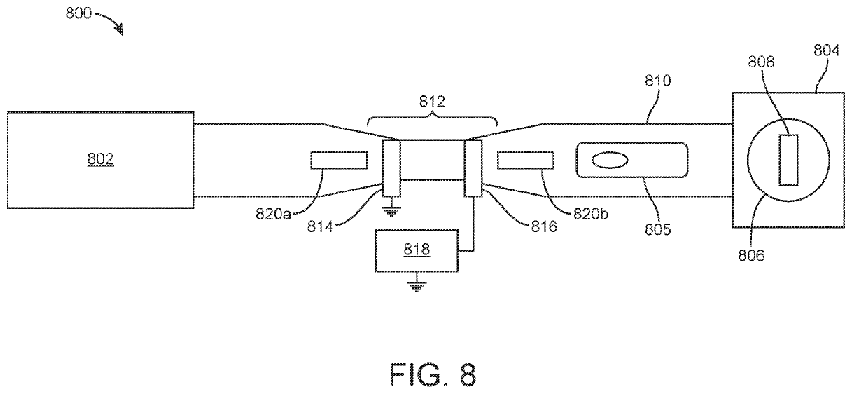

Referring now to FIG. 8, another example schematic diagram of a clog clearing system 800 used within either the fluid ejection device 100 and/or the system 200 is shown, according to some embodiments of the present disclosure. The clog clearing system 800 is similar to the clog clearing system 300 in many respects and includes many of the same components as the clog clearing system 300. For example, the clog clearing system 800 includes a reservoir 802, an ejector 804, a channel 810, and a sense area 812 which are similar to the reservoir 302, the ejector 304, the channel 310, and the sense area 312 respectively of clog clearing system 300 described above. The ejector 804 includes a nozzle 806 and a resistor 808 which are similar to the nozzle 306 and the resistor 308 respectively. The single cell 805 may be similar to single cell 305. The sense area 812 includes a first electrode 814 and a second electrode 816 which are similar to the first electrode 314 and the second electrode 316 respectively. The first electrode 814 and the second electrode 816 may be connected to a sensing circuit 818 which is configured to measure the impedance associated with the sense area 812 similar to sensing circuit 318 described above.

The clog clearing system 800 also includes a first clog clearing device 820a and a second clog clearing device 820b. The first clog clearing device 820a and the second clog clearing device 820b may be activated to clear a clog within the channel 810 based on an impedance value determined by the sensing circuit 818 across the sense area 812. Specifically, the first clog clearing device 820a and the second clog clearing device 820b may be fired at one or more intensities and/or durations to clear the clog. The first clog clearing device 820a and the second clog clearing device 820b may each be similar to clog clearing device 320 described above. In one example, the clog clearing system 800 may differ from the clog clearing system 300 in the number of clog clearing devices present and the placement of the first clog clearing device 820a and the second clog clearing device 820b. Specifically, the first clog clearing device 820a and the second clog clearing device 820b may be placed on either side of the sense area 812. In some examples, the first clog clearing device 820a may be proximate or closer to the sense area 812 than the reservoir 802. In another example, the first clog clearing device 820a may be anywhere between the reservoir 802 and the sense area 812. When the clog is sensed upstream from the sense area 812, the first clog clearing device 820a may be activated to disperse the clog which is upstream from the sense area 812. In some examples, the second clog clearing device 820b may be proximate or closer to the sense area 812 than the ejector 804. In another example, the second clog clearing device 820b may be anywhere between the sense area 812 and the ejector 804. When the clog is sensed between the first electrode 814 and the second electrode 816, the second clog clearing device 820b may be activated to disperse the clog which is between the first electrode 814 and the second electrode 816. In some examples, the second clog clearing device 820b may also be activated when the clog is sensed upstream of the sense are 812 to be fired in conjunction with the first clog clearing device 820a to break up the clog and also push the debris from the clog towards the ejector 804. The first clog clearing device 820a and the second clog clearing device 820b may be configured to clear either sticky cells which may be stuck on the first electrode 814 and the second electrode 816 or clogs which may form on either side of the sense area 812. The first clog clearing device 820a and the second clog clearing device 820b may be fired simultaneously or separately as desired. The first clog clearing device 820a and the second clog clearing device 820b may be different from each other. For example, the first clog clearing device 820a may be a resistor while the second clog clearing device 820b may be a laser or vice versa.

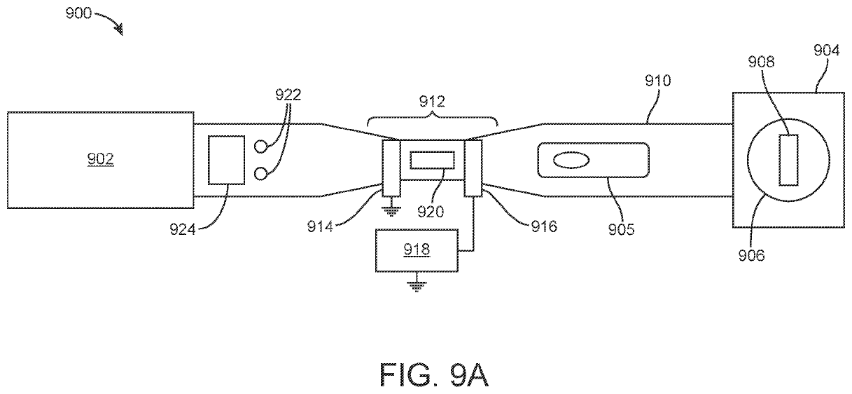

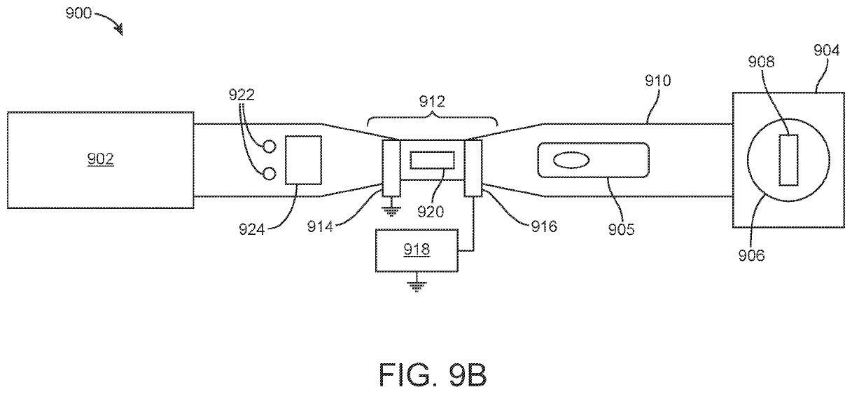

Referring now to FIGS. 9A and 9B, other schematic diagrams of a clog clearing system 900 used within either the fluid ejection device 100 and/or the system 200 is shown, according to some embodiments of the present disclosure. The clog clearing system 900 is similar to the clog clearing system 300 in many respects and includes many of the same components as the clog clearing system 300. For example, the clog clearing system 900 includes a reservoir 902, an ejector 904, a channel 910, and a sense area 912 which are similar to the reservoir 302, the ejector 304, the channel 310, and the sense area 312 respectively of clog clearing system 300 described above. The ejector 904 includes a nozzle 906 and a resistor 908 which are similar to the nozzle 306 and the resistor 308 respectively. The single cell 905 may be similar to single cell 305. The sense area 912 includes a first electrode 914 and a second electrode 916 which are similar to the first electrode 314 and the second electrode 316 respectively. The first electrode 914 and the second electrode 916 may be connected to a sensing circuit 918 which is configured to measure the impedance associated with the sense area 912 similar to sensing circuit 318 described above. The clog clearing system 900 also includes a clog clearing device 920 similar to the clog clearing device 320 for clearing clogs detected within the sense area 912 or upstream from the sense area 912, as described above.

The clog clearing system 900 also includes one or more pillars 922 which are configured to catch clogs before the clog reaches the sense area 912. In some examples, the channel 910 includes one or more pillars 922 proximate the reservoir 902 to catch the clog and the clog clearing device 924 is located between the reservoir 902 and the one or more pillars 922 to disperse the clog caught by the one or more pillars 922. In some examples, the pillars may be formed from a polymer material (e.g., SU-8 material). The one or more pillars 922 may be positioned upstream (e.g., and between the reservoir 902 and the sense area 912) of the sense area 912 in one example. In some examples, pillars may be equally spaced between the walls of the channel 910. In some examples, the pillars 922 may be spaced so that a single cell may pass between and around the pillars 992. In some examples, the pillars 922 may extend between the top and the bottom of the channel 910. The sensing circuit 918 may determine that the one or more pillars 922 have caught a clog when the sensing circuit 918 doesn't sense any cells arriving in a sense area after a predetermined period of time. The clog clearing system 900 also includes a clog clearing device 924 which is placed upstream of the one or more pillars 922, as shown in FIG. 9A. The clog clearing device 924 may be activated to clear the clog caught by the one or more pillars after the sensing circuit 918 has not sensed any cells arriving for the predetermined period of time. Specifically, the clog clearing device 924 may break the clog into smaller pieces allowing the pieces of the clog to pass through the sense area 912 and be ejected when the clog clearing device is placed upstream of the one or more pillars 922. In some examples, the clog clearing system 900 may include a clog clearing device 920 which may be activated to provide clear any clogs or debris which may pass the pillars 922. In some examples, the clog clearing device 920 may be activated after the clog clearing device 924 has been fired to break up the clog formed behind the pillars 922.

In another example, the clog clearing device 924 may be placed downstream of the one or more pillars 922 (e.g., between the one or more pillars 922 and the ejector 904). For example, as shown in FIG. 9B, the clog clearing device 924 is placed downstream of the one or more pillars 922. In such an example, the clog clearing device 924 may be activated to push the clog back into the reservoir 902.

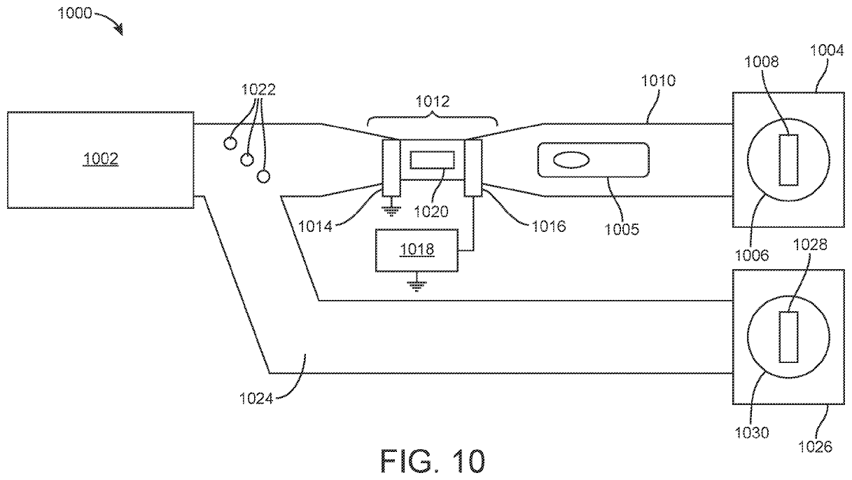

Referring now to FIG. 10, another schematic diagram of a clog clearing fluid ejection device 1000 used within either the fluid ejection device 100 and/or the system 200 is shown, according to some embodiments of the present disclosure. The clog clearing fluid ejection device 1000 is similar to the clog clearing system 300 in many respects and includes many of the same components as the clog clearing system 300. For example, the clog clearing fluid ejection device 1000 includes a reservoir 1002, an ejector 1004, a channel 1010, and a sense area 1012 which are similar to the reservoir 302, the ejector 304, the channel 310, and the sense area 312 respectively of clog clearing system 300 described above. The ejector 1004 includes a nozzle 1006 and a resistor 1008 which are similar to the nozzle 306 and the resistor 308 respectively. The single cell 1005 may be similar to single cell 305. The sense area 1012 includes a first electrode 1014 and a second electrode 1016 which are similar to the first electrode 314 and the second electrode 316 respectively. The first electrode 1014 and the second electrode 1016 may be connected to a sensing circuit 1018 which is configured to measure the impedance associated with the sense area 1012 similar to sensing circuit 318 described above. The clog clearing fluid ejection device 1000 also includes a clog clearing device 1020 similar to clog clearing device 320 for clearing clogs detected within the sense area 1012 or upstream from the sense area 1012, as described above. In some implementations, the clog clearing device 1020 may be or not be included within the clog clearing fluid ejection device 1000 because the clog clearing fluid ejection device 1000 includes an alternative way of clearing clogs from the system (e.g., a junk channel and ejector) as explained in further detail below.

The clog clearing fluid ejection device 1000 also includes one or more pillars 1022 which are configured to catch clogs before the clog reaches the sense area 1012. The one or more pillars 1022 may be positioned upstream of the sense area 1012 in one example. In some example, the pillars 1022 may be formed from a polymer material (e.g., SU-8 material). The one or more pillars 1022 may be spaced so that a single cell such as the single cell 1005 may pass into the sense area 1012 while preventing any larger items such as clogs or junk from passing into the sense area. In some examples, pillars may be equally spaced between the walls of the channel 1010. In some examples, the pillars 1022 may extend between the top and the bottom of the channel 1010. In some examples, the pillars 1022 may be placed at angle however, the pillars may be places in different configurations. In one example, the clog clearing fluid ejection device 1000 includes an additional channel 1024. The clogs caught by the one or more pillars 1022 may be redirected to flow through the additional channel 1024 instead of attempting to pass through the sense area 1012. The additional channel 1024 may include an additional ejector 1026 which may be configured to eject the clog from the additional channel 1024. In one example, the additional ejector 1026 may include a larger nozzle 1030 which may be larger than nozzle 1006 to enable a clog to be ejected from the additional ejector 1026. In one example, the additional ejector 1026 includes a resistor 1028. The resistor 1028 may be activated to create a gas bubble which pushes any junk or debris through the larger nozzle 1030 in order to remove any junk or clogs which may form in the clog clearing fluid ejection device 1000. The junk may be ejected from the additional ejector 1026 into a junk well (e.g., a well not intended to contain a single isolated cell). In some examples, the clog clearing fluid ejection device 1000 may optionally include a clog clearing device 1020 which may be activated to provide clear any clogs or debris which may pass the pillars 1022.

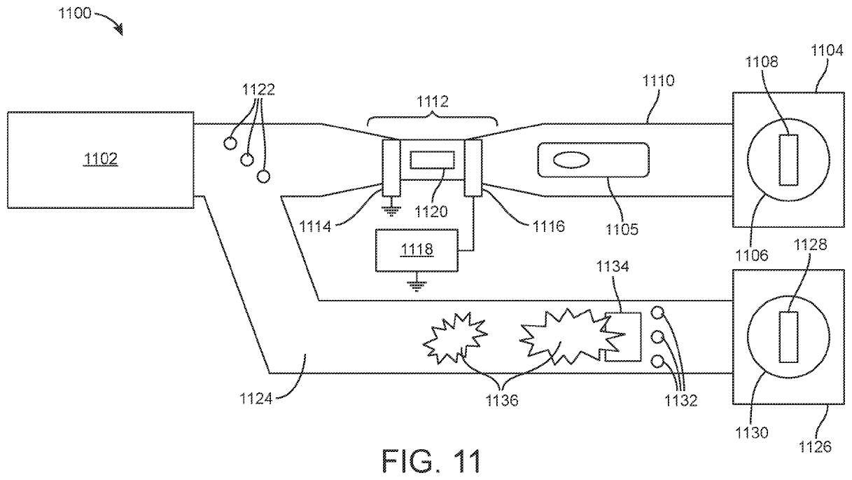

Referring now to FIG. 11, another example schematic diagram of a clog clearing system 1100 used within either the fluid ejection device 100 and/or the system 200 is shown, according to some embodiments of the present disclosure. The clog clearing system 1100 is similar to the clog clearing system 300 in many respects and includes many of the same components as the clog clearing system 300. For example, the clog clearing system 1100 includes a reservoir 1102, an ejector 1104, a channel 1110, and a sense area 1112 which are similar to the reservoir 302, the ejector 304, the channel 310, and the sense area 312 respectively of clog clearing system 300 described above. The ejector 1104 includes a nozzle 1106 and a resistor 1108 which are similar to the nozzle 306 and the resistor 308 respectively. The single cell 1105 may be similar to single cell 305. The sense area 1112 includes a first electrode 1114 and a second electrode 316 which are similar to the first electrode 314 and the second electrode 316 respectively. The first electrode 1114 and the second electrode 1116 may be connected to a sensing circuit 1118 which is configured to measure the impedance associated with the sense area 1112 similar to sensing circuit 318 described above. The clog clearing system 1100 also includes a clog clearing device 1120 similar to clog clearing device 320 for clearing clogs detected within the sense area 1112 or upstream from the sense area 1112, as described above. In some implementations, the clog clearing device 1120 may be optionally included within the clog clearing system 1100 because the clog clearing system 1100 includes an alternative way of clearing clogs from the system (e.g., a junk channel and ejector) as will be explained in further detail below. The clog clearing system 1100 also includes an additional ejector 1126, an additional channel 1124 between the reservoir 1102 and the additional ejector 1126, and a first set of pillars 1122 positioned proximate an entrance of the channel 1110 to catch the clog and redirect the clog to the additional channel 1124. The clog clearing system 1100 also includes a second set of pillars 1132 positioned proximate the additional ejector 1126 to collect the clog redirected from the channel 1110; and an additional clog clearing device 1134 proximate the second set of pillars 1132 to disperse the clog.

The clog clearing system 1100 also includes the first set of pillars 1122 which are configured to catch clogs before the clog reaches the sense area 1112. In some example, the first set of pillars 1122 may be formed from a polymer material (e.g., SU-8 material). The first set of pillars 1122 may be positioned upstream of the sense area 1112 in one example. The first set of pillars 1122 may be spaced so that a single cell such as the single cell 1105 may pass into the sense area 1112 while preventing any larger items such as clogs or junk from passing into the sense area. In some examples, pillars may be equally spaced between the walls of the channel 1110. In some examples, the pillars 1122 may extend between the top and the bottom of the channel 1110. In some examples, the pillars 1122 may be placed at angle however, the pillars may be places in different configurations. Similar to clog clearing fluid ejection device 1000, the clog clearing system 1100 includes the additional channel 1124. The clogs caught by the first set of pillars 1122 may be redirected to flow through the additional channel 1124 instead of attempting to pass through the sense area 1112. The clog clearing system 1100 also includes the second set of pillars 1132 which are configured to catch any additional or clogs which have been redirected to the additional channel 1124 while allowing the cell solution to pass through to the additional ejector 1126. Specifically, the additional ejector 1126 may fire periodically to remove solution from the additional channel 1124 while the clogs accumulate behind the second set of pillars 1132. The clog clearing system 1100 includes the additional clog clearing device 1134 proximate to the second set of pillars 1132. The additional clog clearing device 1134 may be activated to break up the clogs into smaller pieces 1136 which may then be able to pass through the second set of pillars 1132 and be ejected into a junk well by the additional ejector 1126. In one example, the additional ejector 1126 may include a larger nozzle 1130 which may be larger than nozzle 1106 to enable a clog to be ejected from the additional ejector 1126. In one example, the additional ejector 1126 includes a resistor 1128. The resistor 1128 may be activated to create a gas bubble which pushes any junk or debris through the larger nozzle 1130 in order to remove any junk or clogs which may form in the clog clearing system 1100. In some examples, the clog clearing system 1100 may optionally include a clog clearing device 1120 which may be activated to provide clear any clogs or debris which may pass the pillars 1122.

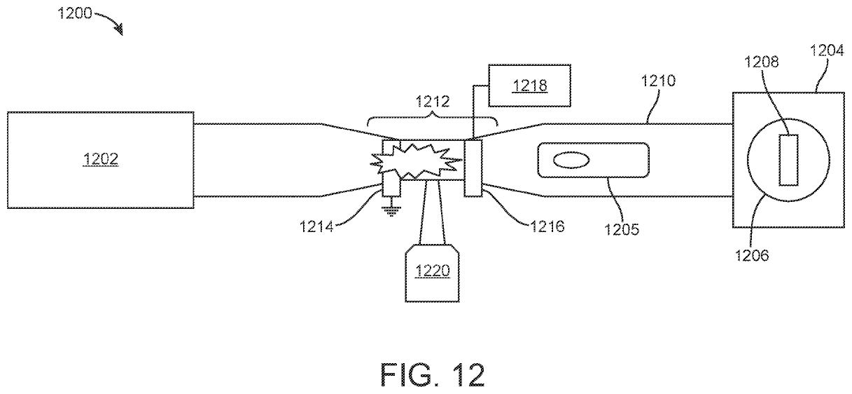

Referring now to FIG. 12, another example schematic diagram of a clog clearing system 1200 used within either the fluid ejection device 100 and/or the system 200 is shown, according to some embodiments of the present disclosure. The clog clearing system 1200 is similar to the clog clearing system 300 in many respects and includes many of the same components as the clog clearing system 300. For example, the clog clearing system 1200 includes a reservoir 1202, an ejector 1204, a channel 1210, and a sense area 1212 which are similar to the reservoir 302, the ejector 304, the channel 310, and the sense area 312 respectively of clog clearing system 300 described above. The ejector 1203 includes a nozzle 1206 and a resistor 1208 which are similar to the nozzle 306 and the resistor 308 respectively. The single cell 1205 may be similar to single cell 305. The sense area 1212 includes a first electrode 1214 and the second electrode 1216 which are similar to the first electrode 314 and the second electrode 316 respectively. The first electrode 1214 and the second electrode 1216 may be connected to a sensing circuit 1218 which is configured to measure the impedance associated with the sense area 1212 similar to sensing circuit 318 described above.

The clog clearing system 1200 also includes a clog clearing device 1220 for clearing clogs detected within the sense area 1212 or upstream from the sense area 1212, as described above. The clog clearing device 1220 may be activated to clear a clog within the channel 1210 based on an impedance value determined by the sensing circuit 1218. The clog clearing device 1220 may be a focused laser which may be activated to shoot a laser beam 1222 through the sense area 1212. The focused laser can adjust the power of the laser beam 1222 in order to accomplish different objectives. For example, the laser beam 1222 may be set at a first power level which may heat the fluid in the sense area 1212 enough to create a gas bubble which may push a clog back into the reservoir 1202. As another example, the laser beam 1222 may be set to a second power level which may heat the fluid in the sense area 1212 enough to break up the clog 1224. The first power level may be lower than the second power level.

Referring now to FIG. 13, another example schematic diagram of a clog clearing system 1300 used within either the fluid ejection device 100 and/or the system 200 is shown, according to some embodiments of the present disclosure. The clog clearing system 1300 is similar to the clog clearing system 300 in many respects and includes many of the same components as the clog clearing system 300. For example, the clog clearing system 1300 includes a reservoir 1302, an ejector 1304, a channel 1310, and a sense area 1312 which are similar to the reservoir 302, the ejector 304, the channel 310, and the sense area 312 respectively of clog clearing system 300 described above. The ejector 1303 includes a nozzle 1306 which may be similar to the nozzle 306. The ejector 1303 also includes a resistor 1308 which may be activated to create a gas bubble which pushes the cell solution containing the single cell 1305 through the nozzle 1306 in order to dispense the single cell 1305. In the example shown in FIG. 13, the resistor 1308 may be larger than the resistor 308. The larger resistor may be more powerful to create a larger a gas bubble and more powerful fluid flow. The single cell 1305 may be similar to single cell 305. The sense area 1312 includes a first electrode 1314 and the second electrode 1316 which are similar to the first electrode 314 and the second electrode 316 respectively. The first electrode 314 and the second electrode 316 may be connected to a sensing circuit 1318 which is configured to measure the impedance associated with the sense area 1312 similar to sensing circuit 318 described above.

The clog clearing system 1300 also includes a clog clearing device 1320 for clearing clogs detected within the sense area 1312 or upstream from the sense area 1312, as described above. The clog clearing device 1320 may be activated to clear a clog within the channel 1310 based on an impedance value determined by the sensing circuit 1318. The clog clearing device 1320 may be similar to clog clearing device 320 described above. In one example, the clog clearing system 1300 may differ from the clog clearing system 300 in the placement of the clog clearing device 1320. The clog clearing device 320 may be placed between the first electrode 314 and the second electrode 316 within the clog clearing system 300. In contrast, the clog clearing device 1320 may be placed upstream of the sense area 1312 between the reservoir 1302 and the first electrode 1314. The placement of the clog clearing device 1320 within the clog clearing system 1300 may be configured to clear clogs which may form upstream of the sense area 1312. Further, the clog clearing system 1300 includes an ejection enhancing resistor 1322 which may be activated at the proper time relative to the clog clearing device 1320. The ejection enhancing resistor 1322 may be placed proximate the ejector 1304. When activated, the ejection enhancing resistor 1322 enhances the pumping of fluid in the channel 1310, increasing the flow velocity in the sense area 1312 and thus improving the chances of clearing a clog. In some examples, the ejection enhancing resistor 1322 proximate the ejector 1304 and configured to increase the flow velocity in the sense area 1312 to enhance dispersing of the clog with the clog clearing device 1320.

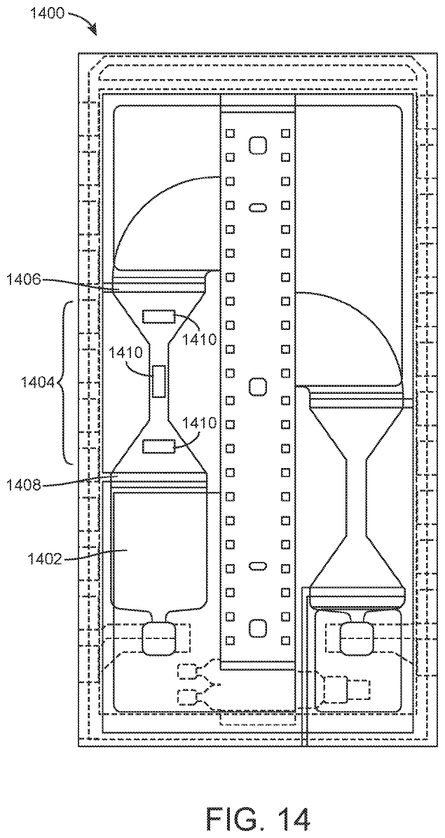

Referring now to FIG. 14, an example electrical transfection system 1400 using one or more clog clearing devices is shown, according to some embodiments of the present disclosure. Electrical transfection refers to a process by which nucleic acids are introduced into eukaryotic cells using electrical means by opening the eukaryotic cell's pores. In some examples, transfection may be done mechanically, electrically, or using a combination of both electrical and mechanical methods of transfection. In one example, electrical transfection may be used by the electrical transfection system 1400. The eukaryotic cells may flow from the fluorescence interrogation region 1402 into an electrical transfection sense area 1404. During mechanical transfection, eukaryotic cells passed through the electrical transfection sense area 1404 are sheared to create openings by which nucleic acids may enter. During electrical transfection, an electrical field may be applied to the eukaryotic cells to create opening within the eukaryotic cells. In the electrical transfection system 1400, the electrical transfection sense area 1404 is flanked by electrodes 1406 and 1408 which create an electrical field which increases the permeability of the eukaryotic cells so that nucleic acids may enter. The electrodes 1406 and 1408 may also be configured to sense whether any eukaryotic cells are trapped within the electrical transfection sense area 1404. In some examples, the electrodes 1406 and 1408 may be connected to a sensing circuit (not pictured) which may be similar to sensing circuit 318 described above. The electrical transfection system 1400 also includes clog clearing devices 1410. The clog clearing devices 1410 may be activated when the sensing circuit determines that any cells are trapped in the electrical transfection sense area 1404. The clog clearing devices may be activated to heat the fluid within the electrical transfection sense area 1404 to increase fluid flow to move any cells which may be trapped. In the example embodiment shown in FIG. 14, the electrical transfection system 1400 includes three clog clearing devices 1410, however the number and placement of the clog clearing devices 1410 may be varied as desired.

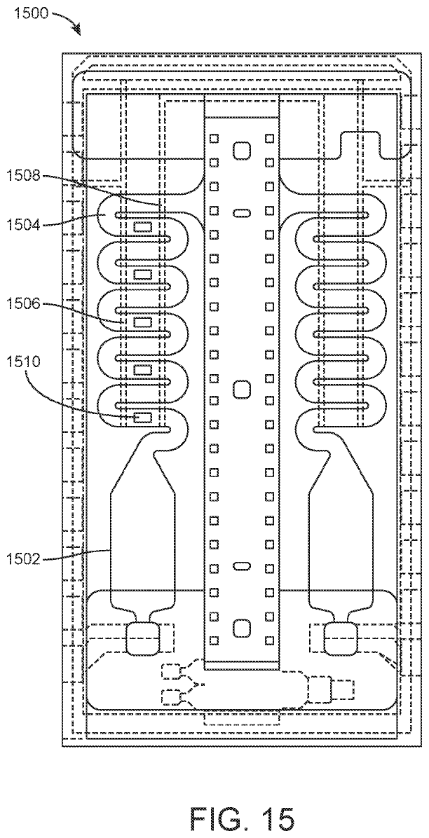

Referring now to FIG. 15, another example electrical transfection system 1500 using clog clearing devices is shown, according to some embodiments of the present disclosure. Similar to electrical transfection system 1500 may utilize mechanical and/or electrical methods of transfection. The eukaryotic cells may flow from the fluorescence interrogation region 1502 into an electrical transfection sense area 1504. In the electrical transfection system 1500, the electrical transfection sense area 1504 may also include electrodes 1506 and 1508 which may create an electrical field within the electrical transfection sense area 1504 which increases the permeability of the eukaryotic cells so that nucleic acids may enter. In some examples, the electrodes 1506 and 1508 may be connected to a sensing circuit (not pictured) which may be similar to sensing circuit 318 described above. The electrodes 1506 and 1508 may also be configured to sense whether any eukaryotic cells are trapped within the electrical transfection sense area 1504. The electrical transfection system 1500 also includes clog clearing devices 1510. The clog clearing devices 1510 may be activated when the sensing circuit determines that any cells are trapped in the electrical transfection sense area 1504. The clog clearing devices 1510 may be activated to heat the fluid within the electrical transfection sense area 1504 to increase fluid flow to move any cells which may be trapped. In the example embodiment shown in FIG. 15, the electrical transfection system 1500 includes three clog clearing devices 1510, however the number and placement of the clog clearing devices 1510 may be varied as desired.

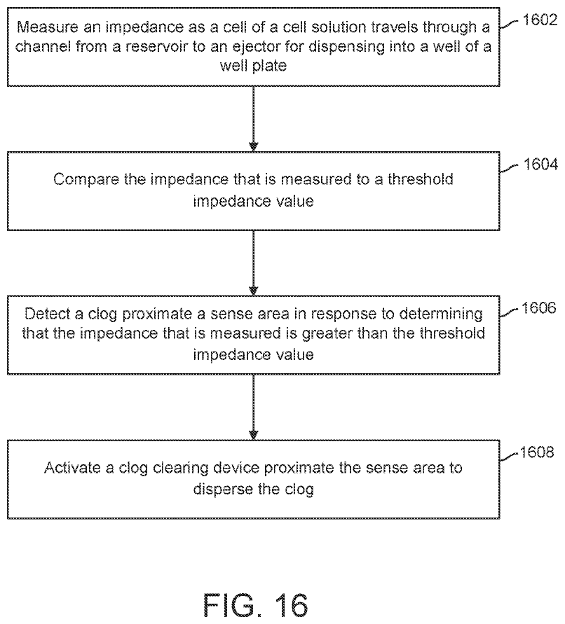

Referring now to FIG. 16, a method 1600 for operating a clog clearing system such as clog clearing systems 300, 700, 800, 900, 1000, 1100, 1200, and 1300 is shown, according to some embodiments of the present disclosure. The method 1600 may include additional, other, or different operations depending on the example. The method 1600 may be used to clear a clog within a fluid ejection device. The method 1600 may be implemented by a single cell dispensing system such as the single cell dispensing systems described above with respect to FIGS. 3 and 7-13.

The method 1600 begins at operation 1602 where the clog clearing system measures, using a sensing circuit in a sense area within a channel connecting a reservoir to an ejector, an impedance as a cell of a cell solution travels through the channel from the reservoir to the ejector for dispensing into a well of a well plate. For example, with reference to the clog clearing system 300, the clog clearing system 300 measures, using the sensing circuit 318 in the sense area 312 within the channel 310 connecting the reservoir to an 302 to the ejector 304, an impedance as the single cell 305 of a cell solution travels through the channel 310 from the reservoir 302 to the ejector 304 for dispensing into a well of a well plate.

At operation 1604, the clog clearing system may then compare the impedance that is measured to a threshold impedance value. For example, with reference to the clog clearing system 300, the clog clearing system 300 may then compare the measurement of the impedance in the sense area measured at operation 1602 with a threshold. Specifically, the clog clearing system 300 may include a controller 402 which may be configured to compare the impedance measurement determined at operation 1602 to a threshold such as the thresholds shown in FIGS. 5 and 6.

At operation 1606, the clog clearing system may then detect a clog proximate the sense area in response to determining that the impedance that is measured is greater than the threshold impedance value. For example, with reference to the clog clearing system 300, the controller 402 may determine that a clog is proximate to the sense area 312 if the impedance measurement passes the threshold. If the impedance measurement stays below the threshold, the controller 402 may determine that the sense area is free of clogs and single cells are sensed.

At operation 1608, the clog clearing system activates a clog clearing device proximate to the sensor to disperse the clog from the sense area. For example, with reference to the clog clearing system 300, the clog clearing system 300 may activate the clog clearing device 320 to disperse the clog from the sense area 312. Specifically, the clog clearing device 320 may be activated by a voltage being applied to the clog clearing device. When the clog clearing device is activated, the clog clearing device heats the fluid around it which either creates a gas bubble to disperse the clog or shears the clog into smaller pieces so that it may pass through the sense area. In one example, the clog clearing device may be a resistor. In another example, the clog clearing device may be focused laser.

In some examples, the sense area 312 includes the first electrode 314 and the second electrode 316, and the clog clearing device 320 is located between the first electrode 314 and the second electrode 316. In some examples, the sense area 712 includes a first electrode 714 and a second electrode 716, and the clog clearing device 720 is located between the reservoir 702 and the sense area 712 proximate the first electrode 714. In some examples, clog clearing device 820 includes a first clog clearing device 820a and a second clog clearing device 820b, wherein the sense area 812 includes a first electrode 814 and a second electrode 816, wherein the first clog clearing device 820a is located between the reservoir 802 and the sense area 812 proximate the first electrode 814, and wherein the second clog clearing device 820b is located between the sense area 812 and the ejector 804 proximate the second electrode 816. In some examples, the clog clearings may display an error message that cell dispensing has stopped after a certain number of failed attempts to disperse the clog from the sense area.

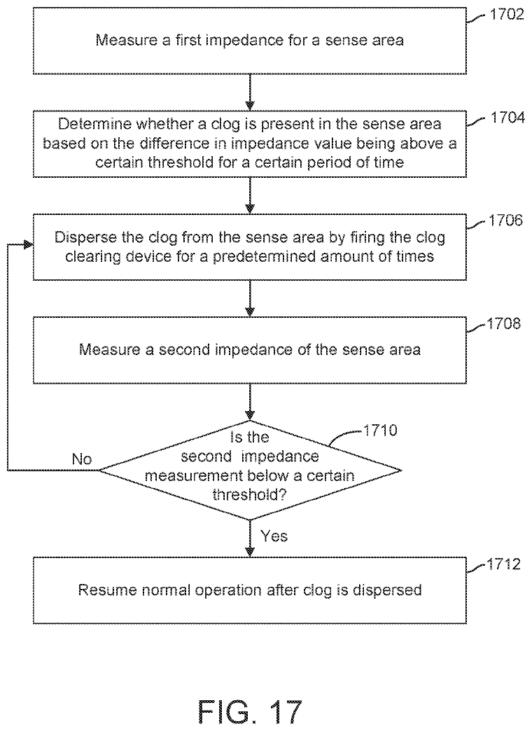

Referring now to FIG. 17, a method 1700 for operating a clog clearing system such as clog clearing systems 300, 700, 800, 900, 1000, 1100, 1200, and 1300 is shown, according to some embodiments of the present disclosure. The method 1700 may include additional, other, or different operations depending on the example. The method 1700 may be used to clear a clog within a fluid ejection device. The method 1700 may be implemented by a single cell dispensing system such as the single cell dispensing systems described above with respect to FIGS. 3 and 7-13.

The method 1700 begins at operation 1702 where the clog clearing system measures an impedance associated with the sense area. For example, with reference to the clog clearing system 300, the clog clearing system 300 may determine the impedance associated the with the sense area 312. As explained above, the sense area includes the first electrode 314 and the second electrode 316 which measures the current flow in the sense area 312. The electrodes may be coupled to a sensing circuit 318 which may receive the measured current from the electrodes and determine an impedance measurement associated with the sense area 312 based on the measured current.

At operation 1704, the clog clearing system determines whether a clog is present in the sense area based on the measurement of the impedance being above a certain threshold for a certain period of time. For example, with reference to the clog clearing system 300, the clog clearing system 300 may determine whether a clog is present in the sense area 312 based on the measurement of the impedance in the sense area measured at operation 1702. Specifically, the clog clearing system 300 may include the controller 402 which may be configured to compare the impedance measurement determined at operation 1702 to a threshold. If the impedance measurement is at or above the threshold, then the controller 402 may determine that a clog is present in the sense area. If the impedance measurement is below the threshold, the controller 402 may determine that the sense area is free of clogs and single cells are sensed.

At operation 1706, the clog clearing system disperses the clog from the sense area with a clog clearing device. For example, with reference to the clog clearing system 300, the controller 402 may activate the clog clearing device 320 to disperse the clog from the sense area 312. Specifically, the clog clearing device 320 may be activated by a voltage being applied to the clog clearing device. When the clog clearing device is activated, the clog clearing device heats the fluid around it which either creates a gas bubble to disperse the clog or shears the clog into smaller pieces so that it may pass through the sense area. In one example, the clog clearing device may be a resistor. In another example, the clog clearing device may be focused laser. In some examples, the clog clearing device 320 may be activated at multiple intensities and for multiple durations. For example, the clog clearing device 320 may be fired at a first intensity for a first duration during the first attempt at dispersing the clog. If the first attempt is unsuccessful, the clog clearing device may be fired at a second intensity which is higher than the first intensity and/or at a second duration which is higher than the second duration.

At operation 1708, the clog clearing system measures a second impedance of a sense area after the clog clearing system has attempted to disperse the clog from the sense area at operation 1706. In some examples, the clog clearing system may measure a second impedance after a predetermined period of time after the clog clearing device has been activated. In some examples, the clog clearing system may not be successful in clearing a clog from the sense area during a first attempt. In such an example, the clog clearing system may attempt to clear the clog from sense area again for a certain amount of times. Therefore, the clog clearing system may make a second impedance measurement to determine whether the clog has been cleared from the sense area.

At operation 1710, the clog clearing system determines whether the second impedance measurement is below a certain threshold. For example, with reference to the clog clearing system 300, the clog clearing system 300 may determine whether a clog is present in the sense area 312 based on the second measurement of the impedance in the sense area measured at operation 1708. Specifically, the clog clearing system 300 may include the controller 402 which may be configured to compare the impedance measurement determined at operation 1708 to a threshold to determine whether the measurement is below a certain threshold. If the second impedance measurement is below a threshold, then the controller 402 determines that the clog was dispersed at operation 1706. If the second impedance measurement is at or above the threshold, then the controller 402 determines the clog was not dispersed at operation 1706 and the method proceeds back to operation 1706 to attempt to disperse the clog again. If the impedance measurement is at or below the threshold, the controller 402 may determine that the sense area is free of clogs. In some examples, the operation 1706 may be repeated for a predetermined amount of times if the clog is not dispersed. If the clog clearing system still fails to clear the clog after the predetermined period of time, the clog clearing system may generate an error message which may be displayed on a user device that dispersing the clog has failed and that cell dispensing has stopped.

Referring now to FIG. 18, an example block diagram of a fluid ejection system 1800 used in association with the fluid ejection devices 100 and/or 200 is shown, according to some embodiments of the present disclosure. In general, the fluid ejection system 1800 ejects fluid onto a substrate. The substrate may be a titration plate having a plurality of wells. The fluid ejection system 1800 may deposit fluid into one or more wells of the titration plate. The substrate may additionally or alternatively include other substrates or surfaces such as microscope slides, matrix assisted laser desorption/ionization (MALDI) plates, and microfluid chips among other substrates or surfaces.

The fluid ejection system 1800 may be configured to eject a single cell into each individual section or chamber within a well plate such as a titration plate with a number of wells, and the fluid may be deposited into the individual wells of the titration plate. The fluid ejection system 1800 may be utilized to eject a variety of different fluids in which it is desired for a single cell to be ejected into each of the individual wells in the well plate. For example, the fluid ejection system 1800 may be implemented in a laboratory and may eject biological fluid. In some examples, the biological fluid may include solvent or aqueous-based pharmaceutical compounds, as well as aqueous-based biomolecules including proteins, enzymes, lipids, antibiotics, mastermix, primer, DNA samples, cells, or blood components, all with or without additives, such as surfactants or glycerol. To eject the fluid, a fluid ejection controller passes control signals and routes them to the fluid ejection device 1802 of the fluid ejection system 1800.

The fluid ejection system 1800 may include one or more fluid ejection devices 1802. The fluid ejection devices 1802 may be similar to the fluid ejection devices 100 and/or 200 described above. Each of the one or more fluid ejection devices 1802 operates to eject fluid onto the surface. In some cases, each of the one or more fluid ejection devices 1802 operates to dispense single cells of a cell solution onto the surface. In some embodiments, the fluid ejection devices 1802 may be a digital dispenser provides rapid delivery of small quantities (e.g., picoliter to microliter) of cell solution into a well plate such as a titration plate with a number of wells, and the fluid may be deposited into the individual wells of the titration plate.

The fluid ejection devices 1802 may include a reservoir 1804. The reservoir 1804 may be similar to the reservoirs 104 and/or 204 described above. The reservoir 1804 holds the fluid to be ejected by the fluid ejection devices 1802. In some examples, the reservoir 1804 is open, or exposed, so that a user, either manually or via a machine-operated multi-channel pipette, can fill the reservoirs 1804 with the cell solution.

The fluid ejection devices 1802 also includes a fluid ejection die 1806. The fluid ejection die 1806 is fluidly coupled to the reservoir 1804. That is, during operation, fluid from the reservoir 1804 is passed to the fluid ejection die 1806 where it is ejected onto the well plate. The fluid ejection die 1806 includes a number of components to eject fluid. For example, the fluid ejection die 1806 may include an ejector (similar to ejector 108 or 208) which is configured to eject the fluid. The fluid ejection die 1806 may also include a channel (e.g., the channel described in FIGS. 1 and 2 above) defining a sense area and clog clearing device (e.g., the clog clearing device of FIGS. 1 and 2). In some examples, the fluid ejection die 1806 and the fluid ejection devices 1802 rely on inkjet technology to eject fluid therefrom. Such a fluid ejection system 1800, by using inkjet components such as ejection chambers, openings, and actuators disposed within the micro-fluid ejection chambers, enables low-volume dispensing of fluids such as those used in life science and clinical applications. Examples of such applications include compound secondary screening, enzyme profiling, dose-response titrations, polymerase chain reaction (PCR) miniaturization, microarray printing, drug-drug combination testing, drug repurposing, drug metabolism and pharmacokinetics (DMPK) dispensing and a wide variety of other life science dispensing.

The fluid ejection die 1806 may include an array of nozzles. Each nozzle includes a number of components. For example, a nozzle includes an ejection chamber to hold an amount of fluid to be ejected, an opening through which the amount of fluid is ejected, and an actuator disposed within the ejection chamber), to eject the amount of fluid through the opening. The nozzle may be similar to nozzles described above with respect to FIGS. 3 and 7-13.

The nozzle may include an actuator such as a firing resistor or other thermal device, a piezoelectric element, or other mechanism for ejecting fluid from the ejection chamber. The firing resistor heats up in response to an applied voltage. As the firing resistor heats up, a portion of the fluid in the ejection chamber vaporizes to form a gas bubble. This bubble pushes fluid out the opening and onto the surface. As the vaporized fluid bubble collapses, fluid is drawn into the ejection chamber from a passage that connects nozzle to a fluid feed slot in the fluidic ejection die, and the process repeats. In this example, the fluidic ejection die may be a thermal inkjet (TIJ) fluidic ejection die.

In another example, the actuator may be a piezoelectric device. As a voltage is applied, the piezoelectric device changes shape which generates a pressure pulse in the ejection chamber that pushes the fluid out the opening and onto the surface. In this example, the fluidic ejection die may be a piezoelectric inkjet (PIJ) fluidic ejection die. In addition to these components, the fluidic ejection die may include a number of fluidic channels and chambers through which the fluid placed in the reservoir 1804 may flow through and out of the nozzles (324).

One embodiment is related to a fluid ejection device. The fluid ejection device includes: a reservoir to contain a cell solution and a fluid ejection die. The fluid ejection die includes an ejector to dispense a cell of the cell solution from the reservoir onto a substrate; a channel connecting the reservoir and the ejector; a sense area within the channel; and a clog clearing device proximate the sense area to clear a clog sensed in the sense area.

In some examples, the sense area comprises a first electrode and a second electrode connected to a sensing circuit to measure an impedance across the sense area as the cell travels from the reservoir to the ejector. In some examples, the cell dispense system includes a controller connected to the sensing circuit, the controller to sense the clog in the sense area in response to the impedance being greater than a threshold value and send a signal to activate the clog clearing device. In some examples, the sense area comprises a first electrode and a second electrode, and the clog clearing device is located between the first electrode and the second electrode. In some examples, the clog clearing device includes a resistor, and wherein in response to receiving the signal, the resistor is configured to heat up and disperse the clog.

In some examples, the cell dispense system includes an enhancing resistor proximate the ejector and configured to increase the flow velocity in the sense area. In some examples, the sense area includes a first electrode and a second electrode, and wherein the clog clearing device is located between the reservoir and the sense area proximate the first electrode. In some examples, the clog clearing device includes a first clog clearing device and a second clog clearing device, wherein the sense area comprises a first electrode and a second electrode, wherein the first clog clearing device is located between the reservoir and the sense area proximate the first electrode, and wherein the second clog clearing device is located between the sense area and the ejector proximate the second electrode.

In some examples, the channel includes one or more pillars proximate the reservoir to catch the clog and the clog clearing device is located between the reservoir and the one or more pillars to disperse the clog caught by the one or more pillars. In some examples, the cell dispense system further includes: an additional ejector; an additional channel between the reservoir and the additional ejector; and a first set of pillars positioned proximate an entrance of the channel to catch the clog and redirect the clog to the additional channel. In some examples, the cell dispense system further includes: a second set of pillars positioned proximate the additional ejector to collect the clog redirected from the first channel; and an additional clog clearing device proximate the second set of pillars to disperse the clog.

Another embodiment is directed to a method. The method includes measuring, using a sensing circuit in a sense area within a channel connecting a reservoir to an ejector, an impedance as a cell of a cell solution travels through the channel from the reservoir to the ejector for dispensing onto a substrate, comparing the impedance that is measured to a threshold impedance value, detecting a clog proximate the sense area in response to determining that the impedance that is measured is greater than the threshold impedance value, and activating a clog clearing device proximate the sense area to disperse the clog.

In some examples, the sense area includes a first electrode and a second electrode, and wherein the clog clearing device is located between the first electrode and the second electrode. In some examples, the sense area comprises a first electrode and a second electrode, and wherein the clog clearing device is located between the reservoir and the sense area proximate the first electrode. In some examples, the clog clearing device comprises a first clog clearing device and a second clog clearing device, wherein the sense area comprises a first electrode and a second electrode, wherein the first clog clearing device is located between the reservoir and the sense area proximate the first electrode, and wherein the second clog clearing device is located between the sense area and the ejector proximate the second electrode. In some examples, the method further includes displaying an error message that cell dispensing has stopped after a certain number of failed attempts to disperse the clog from the sense area.

Yet another embodiment is directed towards a fluid ejection system. The fluid ejection system includes a fluid ejection device. The fluid ejection device includes: a reservoir to contain a cell solution; and a fluid ejection die. The fluid ejection die includes an ejector to dispense a cell of the cell solution from the reservoir onto a substrate, a channel connecting the reservoir and the ejector; a sense area within the channel, and a clog clearing device proximate the sense area to clear a clog sensed in the sense area.

In some examples, the fluid ejection system further comprises a controller connected to a sensing circuit, the controller to sense the clog in the sense area in response to the impedance measured by the sensing circuit being greater than a threshold value and send a signal to activate the clog clearing device, and the clog clearing device comprises a resistor, and wherein in response to receiving the signal, the resistor is configured to heat up and disperse the clog. In some examples, wherein the clog clearing device comprises a resistor or a laser. In some examples, the sense area comprises a first electrode and a second electrode connected to a sensing circuit to measure an impedance across the sense area as the cell travels from the reservoir to the ejector.

The disclosure has been described above with reference to the various examples. However, it is to be understood by those of ordinary skill in the art that various modifications may be made in form and detail without departing from the scope of the disclosure as defined by the appended claims and their equivalents.

The various illustrative logical blocks, circuits, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as firmware or software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A control processor can synthesize a model for an FPGA. For example, the control processor can synthesize a model for logical programmable gates to implement a tensor array and/or a pixel array. The control channel can synthesize a model to connect the tensor array and/or pixel array on an FPGA, a reconfigurable chip and/or die, and/or the like. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An example storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments.

1. A fluid ejection device, comprising:
a reservoir to contain a cell solution; and
a fluid ejection die comprising:
an ejector to dispense a cell of the cell solution from the reservoir onto a substrate;
a channel connecting the reservoir and the ejector;
a sense area within the channel; and
a clog clearing device proximate the sense area to clear a clog sensed in the sense area.

2. The fluid ejection device of claim 1, wherein the sense area comprises a first electrode and a second electrode connected to a sensing circuit to measure an impedance across the sense area as the cell travels from the reservoir to the ejector.

3. The fluid ejection device of claim 2, further comprising:
a controller connected to the sensing circuit, the controller to sense the clog in the sense area in response to the impedance being greater than a threshold value and send a signal to activate the clog clearing device.

4. The fluid ejection device of claim 3, wherein the clog clearing device comprises a resistor, and wherein in response to receiving the signal, the resistor is configured to heat up and disperse the clog.

5. The fluid ejection device of claim 1, wherein the sense area comprises a first electrode and a second electrode, and wherein the clog clearing device is located between the first electrode and the second electrode.

6. The fluid ejection device of claim 5, further comprising an enhancing resistor proximate the ejector and configured to increase the flow velocity in the sense area.

7. The fluid ejection device of claim 1, wherein the sense area comprises a first electrode and a second electrode, and wherein the clog clearing device is located between the reservoir and the sense area proximate the first electrode.

8. The fluid ejection device of claim 1, wherein the clog clearing device comprises a first clog clearing device and a second clog clearing device, wherein the sense area comprises a first electrode and a second electrode, wherein the first clog clearing device is located between the reservoir and the sense area proximate the first electrode, and wherein the second clog clearing device is located between the sense area and the ejector proximate the second electrode.

9. The fluid ejection device of claim 1, wherein the channel comprises one or more pillars proximate the reservoir to catch the clog and the clog clearing device is located between the reservoir and the one or more pillars to disperse the clog caught by the one or more pillars.

10. The fluid ejection device of claim 1, further comprising:
an additional ejector;
an additional channel between the reservoir and the additional ejector; and
a first set of pillars positioned proximate an entrance of the channel to catch the clog and redirect the clog to the additional channel.

11. The fluid ejection device of claim 10, further comprising:
a second set of pillars positioned proximate the additional ejector to collect the clog redirected from the first channel; and
an additional clog clearing device proximate the second set of pillars to disperse the clog.

12. A method comprising:
measuring, using a sensing circuit in a sense area within a channel connecting a reservoir to an ejector, an impedance as a cell of a cell solution travels through the channel from the reservoir to the ejector for dispensing onto a substrate;
comparing the impedance that is measured to a threshold impedance value;
detecting a clog proximate the sense area in response to determining that the impedance that is measured is greater than the threshold impedance value; and
activating a clog clearing device proximate the sense area to disperse the clog.

13. The method of claim 12, wherein the sense area comprises a first electrode and a second electrode, and wherein the clog clearing device is located between the first electrode and the second electrode.

14. The method of claim 12, wherein the sense area comprises a first electrode and a second electrode, and wherein the clog clearing device is located between the reservoir and the sense area proximate the first electrode.

15. The method of claim 12, wherein the clog clearing device comprises a first clog clearing device and a second clog clearing device, wherein the sense area comprises a first electrode and a second electrode, wherein the first clog clearing device is located between the reservoir and the sense area proximate the first electrode, and wherein the second clog clearing device is located between the sense area and the ejector proximate the second electrode.

16. The method of claim 12, further comprising displaying an error message that cell dispensing has stopped after a certain number of failed attempts to disperse the clog from the sense area.

17. A fluid ejection system comprising:
a fluid ejection device comprising:
a reservoir to contain a cell solution; and
a fluid ejection die comprising:
an ejector to dispense a cell of the cell solution from the reservoir onto a substrate;
a channel connecting the reservoir and the ejector;
a sense area within the channel; and
a clog clearing device proximate the sense area to clear a clog sensed in the sense area.

18. The fluid ejection system of claim 17, wherein:
the fluid ejection system further comprises a controller connected to a sensing circuit, the controller to sense the clog in the sense area in response to the impedance measured by the sensing circuit being greater than a threshold value and send a signal to activate the clog clearing device, and
the clog clearing device comprises a resistor, and wherein in response to receiving the signal, the resistor is configured to heat up and disperse the clog.

19. The fluid ejection system of claim 17, wherein the clog clearing device comprises a resistor or a laser.

20. The fluid ejection system of claim 17, wherein the sense area comprises a first electrode and a second electrode connected to a sensing circuit to measure an impedance across the sense area as the cell travels from the reservoir to the ejector.
